(19) United States
(12) Patent Application Publication
(10) Pub. No.: US 2018/0209586 A1
(43) Pub. Date: Jul. 26, 2018

(54) LIQUEFIED GAS STORAGE TANK HAVING INSULATION PARTS AND METHOD FOR ARRANGING INSULATION PARTS

(71) Applicant: DAEWOO SHIPBUILDING & MARINE ENGINEERING CO., LTD., Seoul (KR)

(72) Inventors: Seong Woo PARK, Geoje-si (KR); Kwang Jun PARK, Seoul (KR); Joong Kyoo KANG, Geoje-si (KR)

(73) Assignee: DAEWOO SHIPBUILDING & MARINE ENGINEERING CO., LTD., Seoul (KR)

(21) Appl. No.: 15/744,708

(22) PCT Filed: Apr. 22, 2016
(86) PCT No.: PCT/KR2016/004220

§ 371 Date: Jan. 12, 2018

(30) Foreign Application Priority Data
Jul. 13, 2015 (KR) 10-2015-0099001

(51) Int. Cl. F17C 1/12; F17C 3/02; F17C 13/00

(52) U.S. Cl. CPC F17C 1/12; F17C 3/02; F17C 13/001; F17C 2203/0333; F17C 2270/0105; F17C 2221/035; F17C 2223/0161; F17C 2260/016; F17C 2221/033

(57) ABSTRACT

A liquefied gas storage tank having insulation parts and a method for arranging the insulation parts are disclosed. Disclosed are the liquefied gas storage tank having the insulation parts and the method for arranging the insulation parts, the liquefied gas storage tank being capable of improving durability against the impact generated by liquefied gas since insulation panels, which are arranged in the insulating parts for the liquefied gas storage tank, have different densities according to: a load due to the mass of the liquefied gas stored in the liquefied gas storage tank; and the impact generated by sloshing.

### TECHNICAL FIELD

The present invention relates to a liquefied gas storage tank including a heat insulation part and a method of arranging the heat insulation part, and more particularly, to a liquefied gas storage tank which includes a heat insulation part and can be manufactured at a reduced cost, and a method of arranging the heat insulation part.

### BACKGROUND ART

Since liquefied gas such as liquefied natural gas (LNG) is in a liquid state at a cryogenic temperature under atmospheric pressure, a separate tank capable of storing liquefied gas at a cryogenic temperature is required to transport the liquefied gas.

Such a liquefied gas storage tank includes a heat insulation part to prevent liquefied gas from evaporating due to heat exchange with the outside.

A liquefied gas storage tank is divided into an independent storage tank and a membrane-type storage tank depending on whether a heat insulation part directly receives a load of liquefied gas. In other words, in the independent storage tank, the heat insulation part does not directly receive the load of the liquefied gas, whereas, in the membrane-type storage tank, the heat insulation part directly receives the load of the liquefied gas.

A membrane type storage tank is divided into a NO96 type storage tank and a Mark III type storage tank.

### DISCLOSURE

### Technical Problem

A typical membrane-type storage tank is provided throughout the entire surface thereof with heat insulation panels having the same properties (i.e., the same densities) to achieve only the original purpose, i.e., insulation of liquefied gas from the outside.

A liquefied gas storage tank is continuously impacted by sloshing. Here, “sloshing” refers to movement of a fluid with respect to a tank containing the fluid. During transportation of the fluid, sloshing in the tank can impact and damage to the tank. In other words, impact on the liquefied gas storage tank can be divided into (a) impact due to a load of liquefied gas and (b) impact due to sloshing of the liquefied gas.

A membrane type storage tank, which includes a heat insulation part directly receiving a load of the liquefied gas, includes a portion heavily impacted by sloshing and a portion less impacted by sloshing. If heat insulation panels having the same strengths are disposed over the entire surface of the storage tank without considering this, (1) the portion of the storage tank heavily impacted by sloshing is relatively vulnerable, and (2) the portion of the storage tank less impacted by sloshing causes over-consumption of a heat insulation material.

Therefore, embodiments of the present invention provide a membrane type storage tank which includes a heat insulation part, specifically optimally-disposed heat insulation panels, by taking into account liquefied gas-induced impact on the storage tank.

### Technical Solution

In accordance with one aspect of the present invention, there is provided a liquefied gas storage tank including a heat insulation part, wherein the heat insulation part includes a plurality of regions in which heat insulation panels having different densities are disposed, respectively, the plurality of regions being divided based on impact on the storage tank due to a load of liquefied gas and sloshing of the liquefied gas.

The plurality of regions may include: a first density region formed on a bottom surface of the storage tank; and a second density region formed on upper and side surfaces of the storage tank.

A heat insulation panel disposed in the second density region may have a higher density than a heat insulation panel disposed in the first density region.

The plurality of regions may include: a third density region formed on a bottom surface of the storage tank; a fourth density region formed on front, side and back surfaces of the storage tank; and a fifth density region formed on an upper surface of the storage tank.

A heat insulation panel disposed in the fifth density region may have a higher density than a heat insulation panel disposed in the fourth density region, and a heat insulation panel disposed in the third density region may have a lower density than a heat insulation panel disposed in the fourth density region.

The plurality of regions may further include: a sixth density region formed at a central portion on the upper surface of the storage tank to be surrounded by the fifth density region.

A heat insulation panel disposed in the sixth density region may have a lower density than a heat insulation panel disposed in the fifth density region.

The plurality of regions may further include: a seventh density region formed on a portion of each of the front, side and back surfaces of the storage tank below the fourth density region.

A heat insulation panel disposed in the seventh density region may have a higher density than a heat insulation panel disposed in the fourth density region.

The fourth density region may protrude upwardly toward the fifth density region.

The liquefied gas storage tank may be a membrane-type storage tank.

In accordance with another aspect of the present invention, there is provided a method of arranging a heat insulation part for a liquefied gas storage tank, including: dividing the heat insulation part into a first region under a load of liquefied gas; a second region impacted by sloshing of the liquefied gas; and a third region other than the first region and the second region; and disposing heat insulation panels in the first to third regions, respectively, such that a heat insulation panel disposed in the second region has a higher density than a heat insulation panel disposed in the first region and a heat insulation panel disposed in the third region has a higher density than the heat insulation panel disposed in the first region.

The heat insulation part may include reinforced polyurethane foam (R-PUF).

### Advantageous Effects

According to embodiments of the present invention, in a heat insulation part for a membrane-type storage tank, a heat insulation panel disposed at a portion of the storage tank heavily impacted by sloshing of liquefied gas has a different density than a heat insulation panel disposed at a portion of the storage tank less impacted by sloshing, thereby improving durability of the storage tank against impact due to liquefied gas.

In addition, according to the embodiments of the present invention, a portion of the heat insulation part disposed at a portion of the storage tank less affected by a load of liquefied gas or impact due to the liquefied gas is composed of a heat insulation panel having a relatively low density, thereby enabling optimal use of a heat insulation material.

### DESCRIPTION OF DRAWINGS

FIG. 1 is a perspective view of an exemplary liquefied gas storage tank to which the present invention is applied.

FIG. 2 is a development view of a heat insulation part for a liquefied gas storage tank according to a first embodiment of the present invention.

FIG. 3 is a development view of a heat insulation part for a liquefied gas storage tank according to a second embodiment of the present invention.

FIG. 4 is a development view of a heat insulation part for a liquefied gas storage tank according to a third embodiment of the present invention.

### BEST MODE

Hereinafter, embodiments of the present invention will be described with reference to the accompanying drawings. However, it should be understood that the present invention is not limited to the following embodiments, and that various modifications and equivalent embodiments may be made by those skilled in the art. Therefore, the scope of the present invention is defined only by the claims.

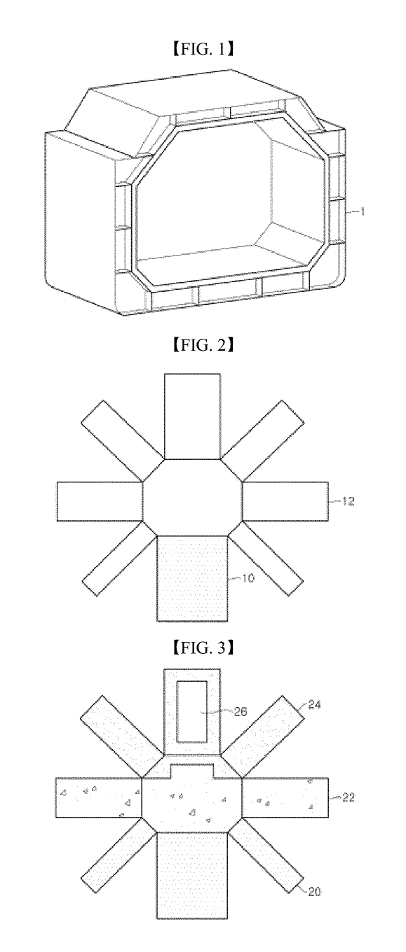

FIG. 1 is a perspective view of an exemplary liquefied gas storage tank to which the present invention is applied.

Referring to FIG. 1, the liquefied gas storage tank 1 may be a membrane-type storage tank. FIGS. 2 to 4 are development views of the liquefied gas storage tank, respectively. In FIGS. 2 to 4, different hatchings indicate different regions, specifically regions of a heat insulation part where heat insulation panels having different densities are disposed, respectively.

Although a front portion of the liquefied gas storage tank 1 is omitted to illustrate the interior of the liquefied gas storage tank 1 in FIGS. 1 to 4, it should be understood that, a front surface of a heat insulation part for a liquefied gas storage tank shown in each of FIGS. 2 to 4 is configured in the same manner as a back surface of the heat insulation part.

A heat insulation panel described below may be formed of reinforced polyurethane foam (R-PUF).

FIG. 2 is a development view of a heat insulation part for a liquefied gas storage tank according to a first embodiment of the present invention.

Referring to FIG. 2, the heat insulation part for the liquefied gas storage tank according to the first embodiment includes a bottom surface, an upper surface, side surfaces consisting of a right-side surface and a left-side surface, a front surface, and a back surface. In addition, the heat insulation part for the liquefied gas storage tank further includes a lower chamfered surface between each of the side surfaces and the bottom surface and an upper chamfered surface between each of the side surfaces and the upper surface.

The heat insulation part for the liquefied gas storage tank according to the first embodiment includes a first density region 10 and a second density region 12 based on the density of a heat insulation panel constituting the heat insulation part. The bottom surface of the heat insulation part for the liquefied gas storage tank corresponds to the first density region 10, and the other surfaces of the heat insulation part, including the upper and lower chamfered surfaces, correspond to the second density region 12. Here, a heat insulation panel disposed in the second density region 12 may have a higher density than a heat insulation panel disposed in the first density region 10.

For example, the heat insulation panel disposed in the first density region 10 may have a density of about 130 kg/m³, and the heat insulation panel disposed in the second density region 12 may have a density of about 210 kg/m³.

The heat insulation part for the liquefied gas storage tank according to the first embodiment may be used in an offshore floating vessel fueled by liquefied gas. As the offshore floating vessel fueled by liquefied gas is operated, the amount of the liquefied gas in a liquefied gas storage tank of the offshore floating vessel is gradually decreased. Thus, the storage tank is impacted by sloshing at varying portions thereof during operation of the offshore floating vessel. In other words, in an early stage of operation in which a relatively large amount of the liquefied gas is stored in the liquefied gas storage tank, an upper portion of each of front and back surfaces, side surfaces, an upper chamfered surface, and an upper surface of the liquefied gas storage tank are impacted by sloshing, whereas, in a later stage of operation in which the amount of the liquefied gas in the liquefied gas storage tank is decreased, a lower portion of each of the front and back surfaces, the side surfaces, and a lower chamfered surface of the liquefied gas storage tank are impacted by sloshing.

On the other hand, factors of liquefied gas-induced impact on the liquefied gas storage tank are mainly divided into (a) the load of the liquefied gas on a bottom surface of the liquefied gas storage tank and (b) sloshing of the liquefied gas against the upper surface, the side surfaces, the front surface, the back surface, or the upper and lower chamfered surfaces of the storage tank. Generally, the impact on the storage tank due to (b) is greater than the impact on the storage tank due to (a). Accordingly, the heat insulation panel disposed in the first density region 10 may have a relatively low density, whereas the heat insulation panel disposed in the second density region 12 may have a relatively high density.

FIG. 3 is a development view of a heat insulation part for a liquefied gas storage tank according to a second embodiment of the present invention.

Referring to FIG. 3, the heat insulation part for the liquefied gas storage tank according to the second embodiment of the present invention includes different density regions than the heat insulation part according to the first embodiment. In other words, a bottom surface and a lower chamfered surface of the heat insulation part correspond to a third density region 20, a central portion and lower portion of each of front and back surfaces and a side surface of the heat insulation part correspond to a fourth density region 22, and at least a portion of the upper surface, an upper portion of each of the front and back surfaces, and an upper chamfered surface of the heat insulation part correspond to a fifth density region 24. In addition, a central portion of the upper surface may correspond to a sixth density region 26, and thus the rest of the upper surface excluding the central portion may correspond to the fifth density region 24.

As shown in FIG. 3, the central portion of each of the front and back surfaces, corresponding to the fourth density region 22, may upwardly protrude toward the upper portion of each of the front and back surfaces, that is, the fifth density region 24; the sixth density region 26 may be formed in a rectangular shape at the central portion of the upper surface; and the fifth density region 24 may surround the rectangular sixth density region 26.

A heat insulation panel disposed in the fifth density region 24 may have a higher density than a heat insulation panel disposed in the fourth density region 22, and a heat insulation panel disposed in the fourth density region 22 may have a higher density than a heat insulation panel disposed in the third density region 20. In addition, a heat insulation panel disposed in the fifth density region 24 may have a higher density than a heat insulation panel disposed in the sixth density region 26.

For example, the heat insulation panel disposed in the third density region 20 may have a density of about 100 kg/m³, the heat insulation panel in each of the fourth density region 22 and the sixth density region 26 may have a density of about 130 kg/m³, and the heat insulation panel disposed in the fifth density region 24 may have a density of about 210 kg/m³.

The heat insulation part for the liquefied gas storage tank according to the second embodiment may be used in an offshore floating vessel having a storage tank storing liquefied gas as a cargo, such as an LNG carrier. Unlike the liquefied gas storage tank according to the first embodiment, a liquefied gas storage tank of the offshore floating vessel storing or carrying a liquefied gas cargo is fully filled with liquefied gas or is empty. Thus, in the second embodiment of the present invention, it is not necessary that the entirety of the heat insulation part excluding the bottom surface be composed of a heat insulation panel having a relatively high density.

In the second embodiment, a heat insulation panel constituting at least a portion of the upper portion of each of the front and back surfaces, at least a portion of the upper surface, and the upper chamfered surface of the heat insulation part, which are heavily impacted by sloshing, may have a relatively high density; a heat insulation panel constituting the central portion and lower portion of each of the front and back surfaces, the side surfaces, and the central portion of the upper surface of the heat insulation part, which are relatively less impacted by sloshing, may have a relatively intermediate density; and a heat insulation panel constituting the bottom surface and the lower chamfered surface of the heat insulation part, which are mainly impacted by a load of liquefied gas while being impacted little by sloshing, may have a relatively low density.

An edge of the upper surface of the heat insulation part is relatively heavily impacted by sloshing, whereas the central portion of the upper surface is relatively less impact by sloshing. Accordingly, a heat insulation panel constituting the edge of the upper surface may have a relatively high density, and a heat insulation panel constituting the central portion of the upper surface may have a relatively low density.

Generally, a heat insulation panel attached to the liquefied gas storage tank has a rectangular shape. According to the present invention, the central portion of each of the front and back surfaces of the heat insulation part, corresponding to the fourth density region 22, may protrude in an angular rectangular shape toward the fifth density region 24, as shown in FIG. 3, such that the effects of the present invention can be achieved without a separate heat insulation panel having a shape other than a rectangular shape. In addition, the central portion of the upper surface of the heat insulation part, corresponding to the sixth density region 26, may have a rectangular shape such that the effects of the present invention can be achieved without a need to provide a separate heat insulation panel.

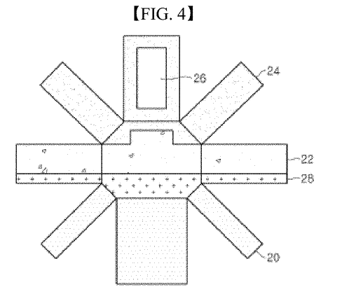

FIG. 4 is a development view of a heat insulation part for a liquefied gas storage tank according to a third embodiment of the present invention.

The heat insulation part for the liquefied gas storage tank according to the third embodiment shown in FIG. 4 is basically the same as the heat insulation part of the liquefied gas storage tank according to the second embodiment shown in FIG. 3. Thus, the following description will focus on the difference between the heat insulation part according to the third embodiment shown in FIG. 3.

Referring to FIG. 4, the heat insulation part for the liquefied gas storage tank according to the third embodiment further includes a seventh density region 28 formed at a lower portion of each of the front and back surfaces and the side surface thereof. A heat insulation panel disposed in the seventh density region 29 may have a higher density than a heat insulation panel disposed in the fourth density region 22. For example, the heat insulation panel constituting the seventh density region 28 may have a density of about 210 kg/m³.

The heat insulation part for the liquefied gas storage tank according to the third embodiment may be used in an offshore floating vessel having a storage tank storing liquefied gas as a cargo, such as an LNG carrier, as in the second embodiment. However, the heat insulation part according to the third embodiment may be used in a storage tank having a different capacity than the storage tank to which the heat insulation part according to the second embodiment is applied.

When a relatively small amount of liquefied gas is stored in the storage tank, the lower portion of each of the front and back surfaces and the side surfaces of the heat insulation part can be heavily impacted by sloshing during carriage of liquefied gas. Accordingly, the heat insulation part according to this embodiment further includes the seventh density region 28 in which a heat insulation panel having a relatively high density is disposed at portions of the front, side and back surfaces of the heat insulation part below the fourth density region 22, thereby exhibiting improved durability.

Although some embodiments have been described herein, it should be understood that these embodiments are provided for illustration only and are not to be construed in any way as limiting the present invention, and that various modifications, changes, alterations, and equivalent embodiments can be made by those skilled in the art without departing from the spirit and scope of the invention. The scope of the present invention should be defined by the appended claims and equivalents thereof.

1. A liquefied gas storage tank comprising a heat insulation part,
wherein the heat insulation part comprises a plurality of regions in which heat insulation panels having different densities are disposed, respectively, the plurality of regions being divided based on impact on the storage tank due to a load of liquefied gas and sloshing of the liquefied gas.

2. The liquefied gas storage tank according to claim 1, wherein the plurality of regions comprises: a first density region formed on a bottom surface of the storage tank; and a second density region formed on upper and side surfaces of the storage tank.

3. The liquefied gas storage tank according to claim 2, wherein a heat insulation panel disposed in the second density region has a higher density than a heat insulation panel disposed in the first density region.

4. The liquefied gas storage tank according to claim 1, wherein the plurality of regions comprises: a third density region formed on a bottom surface of the storage tank; a fourth density region formed on front, side and back surfaces of the storage tank; and a fifth density region formed on an upper surface of the storage tank.

5. The liquefied gas storage tank according to claim 4, wherein a heat insulation panel disposed in the fifth density region has a higher density than a heat insulation panel disposed in the fourth density region, and a heat insulation panel disposed in the third density region has a lower density than a heat insulation panel disposed in the fourth density region.

6. The liquefied gas storage tank according to claim 4, wherein the plurality of regions further comprises: a sixth density region formed at a central portion on the upper surface of the storage tank to be surrounded by the fifth density region.

7. The liquefied gas storage tank according to claim 6, wherein a heat insulation panel disposed in the sixth density region has a lower density than a heat insulation panel disposed in the fifth density region.

8. The liquefied gas storage tank according to claim 6, wherein the plurality of regions further comprises: a seventh density region formed at a portion of each of the front, side and back surfaces of the storage tank under the fourth density region.

9. The liquefied gas storage tank according to claim 8, wherein a heat insulation panel disposed in the seventh density region has a higher density than a heat insulation panel disposed in the fourth density region.

10. The liquefied gas storage tank according to claim 4, wherein the fourth density region upwardly protrudes toward the fifth density region.

11. The liquefied gas storage tank according to claim 1, wherein the liquefied gas storage tank is a membrane-type storage tank.

12. A method of arranging a heat insulation part for a liquefied gas storage tank, comprising:
dividing the heat insulation part into a first region under a load of liquefied gas; a second region impacted by sloshing of the liquefied gas; and a third region other than the first region and the second region; and
disposing heat insulation panels in the first to third regions, respectively, such that a heat insulation panel disposed in the second region has a higher density than a heat insulation panel disposed in the first region and a heat insulation panel disposed in the third region has a higher density than the heat insulation panel disposed in the first area.

13. The method according to claim 12, wherein the heat insulation part comprises reinforced polyurethane foam (R-PUF).
